(19) United States
(12) Patent Application Publication
(10) Pub. No.: US 2002/0081407 A1
(43) Pub. Date: Jun. 27, 2002

(54) Clothing element

(76) Inventor: Goetz Heine, Mindelheim (DE)

Correspondence Address: VENABLE, BAETJER, HOWARD AND CIVILETTI, LLP, P.O. BOX 34385, WASHINGTON, DC, 20043-9998, US

(21) Appl. No.: 09/861,556

(22) Filed: May 22, 2001

(30) Foreign Application Priority Data
Dec. 22, 2000 (DE) 200 21 700.3

(51) Int. Cl. B32B 1/02

(52) U.S. Cl. 428/35.3; 428/34.1; 428/131

(57) ABSTRACT

A clothing element includes a carrier of a form that conforms to a portion of a body surface and an adherent coating made of titanium or of a titanium alloy and/or titanium compound located on one side of the carrier facing the body surface. The adherent coating increases the physical performance and the physical wellness of a body by for example, positively influencing muscle contractility and vasoactivity, and counter-acting signs of fatigue and formation of sweat.

The invention relates to a clothing element according to the preamble of claim 1.

Hereby, an inner sole or insole—specifically for a sport shoe/boot—or also a sock or long sock is particularly concerned, which is in particular worn in the sport and fitness or wellness field, Basically, the invention can also be realized in other clothing elements such as a headband or a cap, a glove or in arm, leg or other bandages or the like.

Inner soles or insoles for footwear having metallic elements are specifically known,

Thus, an inner sole is described in U.S. Pat. No. 4,015,347, which is supposed to have a healing or injury-preventing action by means of a metallic layer consisting of silver, copper or an alloy thereof. The metals are incorporated in the plastic material of the inner sole in the form of small particles.

In U.S. Pat. No. 4,151,660, a deodorant sock for being worn in footwear is described, containing a core of a copper-containing metal having a deodorant action known per se.

In DE 29 12 793 A1, a shoe insole having a multilayer structure, which inter alia comprises a latex layer containing activated carbon powder, copper powder and magnetic powder, as well as a method for producing such an insole is described. This insole is supposed to exhibit a deodorant, fungicidal and magnetizing action.

In DE 34 00 049 A1, a further specific inner sole is described, which is supposed to achieve a blood circulation-promoting action in that rivet heads of copper are provided on its side facing the foot. So as to additionally achieve a deodorant action, a layer of finely ground activated carbon filter material is provided on the side of the inner sole facing towards the shoe.

In DE 37 34 950 A1, an inner sole having an orthopedic support function is described, comprising a cover layer of a material which is kind to the skin such as, for example, leather or a textile top material, and comprising—in a specific configuration—a reinforcement layer of a metal (in particular spring steel).

DE 37 37 302 A1 describes an inner sole of conventional materials and of conventional structure, containing metallic germanium or a germanium-containing material in a finely dispersed form. In preferred embodiments, the material is applied on a carrier by spraying, coating or imprinting of a dispersion.

In DE 39 42 094 A1, an inner sole and insole for a shoe of a hard material is described, which are intended to protect and support the foot.

In U.S. Pat. No. 5,001,848, an inner sole having a metallic core is described, at least one portion of which being formed by an amorphous metal foil. This inner sole is extremely flexible, and is particularly supposed to offer a protection against damages to the shoe or injuries of the wearer caused by pointed objects.

The known inner soles, insoles or socks of the described kind are supposed to mainly achieve a deodorant, in part also a fungicidal or mechanically stabilizing action.

The invention, however, is based on the object of providing for a clothing element exhibiting advantageous actions as to the physical fitness and the wellness, respectively, of the user.

This task is solved by a clothing element having the features of claim 1.

The invention embraces the basic idea of providing a carrier adapted in its respective area to the specific application and to the shape of the body surface with a thermally and electrically conductive and extremely biocompatible coating. Such a coating has a cooling action, as well as bioelectrical actions, which, by means of appropriate specific configurations of the carrier and/or the coating can be optimized for specific application situations. The invention moreover embraces the idea of selecting titanium or a titanium alloy and/or titanium compound as the material for this coating.

The proposed clothing element positively influences muscle contractility and vasoactivity, and counter-acts signs of fatigue and the formation of foot sweat.

In a particularly appropriate configuration for a plurality of applications, due to the cancellation of mechanical influences of the coating with respect to the carrier, the coating is configured as a thin layer. In this form, it can be applied on the carrier in particular by a vacuum deposition process such as evaporation coating or sputtering. Its thickness can be set in particular to a range between 1 μm and 100 μm, preferably between 5 μm and 20 μm.

For applications with a high abrasion risk—for example for inner soles or insoles—one will preferably select a higher thickness, all the more, since with clothing elements of the mentioned kind, a reinforcing action of higher layer thicknesses scarcely counts as being a disadvantage. In contrast thereto, a coating of carriers for clothing elements of a high flexibility—e.g. caps, headbands or gloves—is rather to be provided in a lower layer thickness.

For increasing the adhesive capacity of the coating and hence, for prolonging the lifetime (or efficiency duration of the advantageous action) of the clothing element, a suitable adhesion agent layer can be provided between the surface of the carrier and the proposed coating. Adhesion agent layers for improving the adhesive capacity of metal layers on plastic materials are known per se and therefore do not require a detailed description in this case.

The material of the carrier is to be selected to a large extent in dependence on the materials known for the respective purpose of use. Preferred from the present point of view are flexible plastic carriers, which can in particular comprise polyacrylonitrile fibres, polyester fibres and/or polyamide fibres. Inner soles or insoles can also be pre-fabricated as a formed solid plastic part and be provided with the coating. Moreover, the use of textiles or knit fabrics of the mentioned materials—or also of other textile fibres—lends itself for many applications. Among these count realizations such as knitwear (e.g. undershirts, shorts or T-shirts), overalls for sport or working purposes or other pieces of outer garments.

For “high end” applications, e.g. for inner soles or insoles of high-performance sport shoes/boots for cyclist, triathletes or skiers, carriers with a carbon fibre portion can be advantageously used. Particularly carbon fibre-reinforced plastics distinguish in a known manner by excellent mechanical properties, and the combination thereof with the advantageous performance-increasing actions of the proposed coating enables the production of high-quality clothing elements—in particular sport shoes/boots—for high-performance sports.

For a plurality of applications, the entire surface of the carrier facing the body will essentially be provided with the titanium coating; for other applications, however, a merely partial coating is purposeful. The coated surfaces are in this case predetermined in particular as to physiological or bio-electrical aspects. With the configuration, the findings of modern physiotherapy can inter alia be used.

An improved ventilation of the body area covered with the coated carrier can be obtained, if necessary, by a carrier provided with recesses. These recesses can in particular be formed by throughholes through the entire thickness of the carrier; alternatively, the provision of grooves acting as air channels on the side of the carrier facing the body surface is also possible. It is understood that the above-mentioned textiles and knit fabrics allow for a certain ventilation of the body surface already due to the specificity of the material compound—hereby, however, additional, larger recesses are purposeful in specific configurations.

Furthermore, the carrier can have a grid-like or net-like configuration, and namely independent of a textile structure. Thus, even a semi-rigid inner sole or insole of solid material can eventually have at least in part—a grid-structure.

Preferred embodiments of the invention are shown in the enclosed drawing wherein

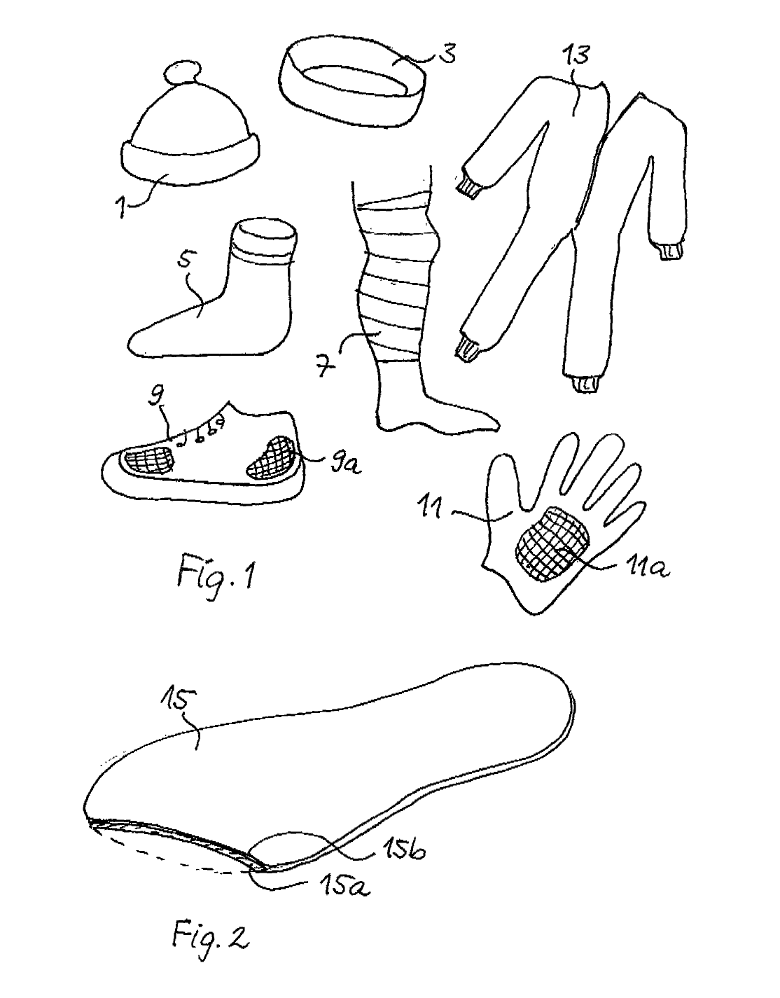

FIG. 1 schematically shows a variety of clothing elements comprising the inventive coatings,

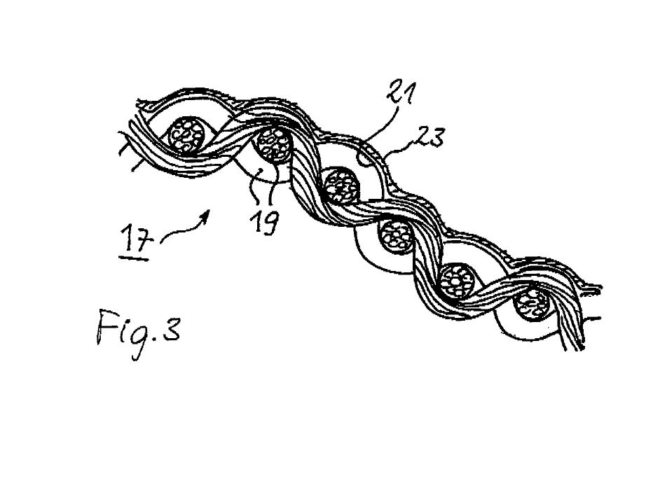

FIG. 2 shows a perspective view of an insole according to a further embodiment of the invention, and

FIG. 3 shows a (simplified) cross-section of a fabric comprising the inventive coating according to a further embodiment of the invention.

In FIG. 1, a cap 1, a headband 3, a sport sock 5, a bandage 7, a sport shoe 9, a glove 11, and an overall 13 are shown which all comprise a carrier material the form of which is adapted to a portion of the body surface when in use and which on one side of the carrier facing the body have an adherent coating of titanium or at titanium alloy.

The sport shoe 9 as well as the glove 11 comprise portions 9a or 11a, respectively, where they have a grid-like or net-like carrier which is coated with titanium or a titanium alloy as well.

All shown clothing elements—expect parts of the sport shoe 9 —are made from a fabric carrier which is preferably made of polyacrylonitrile, polyester and/or polyamid fibres. The coating is provided on one side of the fabric as a whole or, alternatively, on the single fibres; see below.

FIG. 2 shows an insole 15, especially suitable for a sport shoe, which is composed of a flexible plastic carrier 15a comprising carbon fibres (not shown) for improving the mechanical stability and a very thin, sputtered titanium alloy coating 15b.

FIG. 3 shows a cross-section of a fabric 17 (which may be used e.g. for producing some of the clothing elements shown in FIG. 1) which is composed of woven fibres 19. The fabric 17 is, on its upper surface 17a, coated with a first coating layer 21 of an adhesion agent and a second coating 23 of metallic titanium or a titanium compound, respectively. The intermediate layer 21 serves for improving the adhesion of the metallic or compound layer 23 to the fibres and for improving the flexibility thereof to avoid cracks and other damages during the practical use of the fabric.

The realization of the invention is not restricted to the above-mentioned construction and application examples, but it is likewise possible in a plurality of variations, which are within the scope of the skilled person's proceedings.

1. Clothing element comprising a carrier with its form adapted or adapting when in use to a portion of the body surface, and comprising on one side of the carrier facing the body, an adherent coating comprising titanium or of a titanium alloy and/or titanium compound for increasing the physical performance and the physical wellness, respectively.

2. Clothing element according to claim 1, characterized in that the coating is configured as a thin layer produced on the carrier in particular by means of a vacuum deposition process.

3. Clothing element according to claim 1, characterized in that between the coated surface of the carrier and the coating, a layer of an adhesion agent is provided.

4. Clothing element according to claim 1, characterized by a flexible carrier substantially comprised of plastic and comprising in particular polyacrylonitrile fibres, polyester fibres and/or polyamide fibres.

5. Clothing element according to claim 1, characterized in that the carrier comprises carbon fibres.

6. Clothing element according to claim 1, characterized in that the entire surface of the carrier facing the body is substantially provided with the coating.

7. Clothing element according to claim 1, characterized in that the surface of the carrier facing the body is in part provided with the coating in areas predetermined in particular according to physiological and bioelectrical aspects, respectively.

8. Clothing element according to claim 1, characterized in that the carrier comprises recesses, in particular throughholes, for ventilating the body surface covered by the carrier in the operational state.

9. Clothing element according to claim 8, characterized by a grid-like or net-like carrier.

10. Clothing element according to claim 1, characterized by a woven or knitted carrier, the threads of which are at least in part individually coated.

11. Clothing element according to claim 1, configured as an inner sole or insole for a sport shoe/boot.

12. Clothing element according to claim 10, configured as a sport sock.

13. Clothing element according to claim 10, configured as an undershirt, shorts, T-shirt or sweater.

14. Clothing element according to claim 10, configured as an overall.

15. Clothing element according to claim 10, configured as a headband or cap.

16. Clothing element according to claim 10, configured as a glove.

17. Clothing element according to claim 10, configured as a bandage.
